(19) United States
(12) Patent Application Publication
(10) Pub. No.: US 2011/0021651 A1
(43) Pub. Date: Jan. 27, 2011

(54) FIREPROOF FOAM COMPOSITIONS

(75) Inventors: Jean-Pierre Mayeres, Eupen (BE); Denis Job, Angleur (BE); Leila Bonnaud, Maubeuge (FR); Michael Alexandre, Ougree (BE); Philippe Dubois, Braives (BE); Fouad Laoutid, Lambersart (FR)

Correspondence Address: WITHROW & TERRANOVA, P.L.L.C., 100 REGENCY FOREST DRIVE, SUITE 160, CARY, NC, 27518, US

(73) Assignee: NMC S.A., Eynatten (BE)

(21) Appl. No.: 12/864,323

(22) PCT Filed: Jan. 23, 2009
(86) PCT No.: PCT/EP2009/050768

§ 371 Date: Oct. 6, 2010

(30) Foreign Application Priority Data
Jan. 25, 2008 (EP) 08150689.1
Jun. 6, 2008 (EP) 08157798.3

(51) Int. Cl. C08J 9/00

(52) U.S. Cl. 521/79; 521/85

(57) ABSTRACT

The invention relates to a method for making a fireproof polymer foam, and to a fireproof polymer foam containing a mixture of a polymer composition containing one or more optionally-substituted, sequenced or random, thermoplastic and/or elastomer homopolymers, copolymers or mixtures thereof, from 0.05 to 10 wt %, preferably from 0.5 to 5 wt %, relative to the mixture, of carbon nanotubes, and from 0.05 to 15 wt %, preferably from 0.5 to 10 wt %, relative to the mixture, of red phosphorus.

### TECHNICAL FIELD

The present invention relates to flame-retardant polymeric foams with improved fire resistance, and also to a process for preparing these foams and to the use thereof.

### PRIOR ART

The use of halogenated fire retardants or flame retardants as additives has been known for a long time, even in combination with synergists, such as antimony trioxide. By virtue of the incorporation of these halogenated agents, it is possible to obtain very advantageous flame-retardant performance even at relatively low concentrations of flame retardant, of 2% to 15% by weight. These reduced contents are acceptable for manufacturing low-density foams (<60 kg/m³) obtained by direct injection of extrusion gases, for instance in the case of polyolefin-based foams.

However, in view of the potential risks generally associated with these halogenated compounds, the regulations that are currently being deliberated threaten a total ban of these halogenated compounds in the near future. Decabromodiphenyl ether is a current example under discussion as regards its potential for formation of toxic dioxins.

It is also known practice to add other flame retardants, especially in addition to or in replacement for these halogenated compounds, especially to polyolefins in order to increase their fire resistance. The additives conventionally used are, for example, antimony trioxide, ammonium sulfate and borax, and also metal hydroxides.

However, using fireproofing agents in polymeric foams depends greatly on the amount (concentration) and characteristics of the fireproofing agent (especially the melting point and the particle size) that needs to be used in order to obtain a given fire resistance (fire classification in a standardized test), which itself is dependent on the density, the chemical nature (polymer, crosslinking or non-crosslinking) and the thickness of the foam. The type and characteristics of the process for obtaining the foams also have a consequence on the content of fireproofing agent that may be incorporated while preserving the feasibility and quality of the foam. For example, in processes in which the gas is injected into the extrusion equipment: when the fireproofing agent has a high melting point relative to the bulk temperatures reached in the foaming process, it may turn out that the fireproofing agent does not melt during the transformation, or else it melts in a first step but recrystallizes at the end of the process on account of the lower temperatures generally desired in the forming tools to bring about foaming (increased viscosity of the polymer and thus better stabilization of the polymer-surrounded gas bubbles). Thus, it is observed that it is impossible to charge a low-density (<60 kg/m³) crosslinked or non-crosslinked polyolefin foam, manufactured according to the process by direct injection of gases on extrusion, with a large amount of particles of mineral or organic type, with a melting point such that it is unmeltable, or meltable but ultimately crystallizing during the transformation. This is due to the fact that since these particles remain solid after the transformation, they have an interaction with the foaming agent during the expansion in the extrusion tool where the temperature is lower, thus giving rise to a profusion of very fine cells. This may, on the one hand, reduce the foaming capacity of the mixture and/or, on the other hand, lead to coalescence of the cells into cavities and make the foam structure heterogeneous.

As examples of high-melting mineral or organic non-halogenated flameproofing agents, mention may be made of aluminum trihydroxides (300° C.) and magnesium trihydroxides (350° C.) (which release water at higher temperature), expandable carbon graphite, melamine cyanurate (350° C.), etc. The particle size of these particles is also an important factor, since very large particles create large cells. Although non-halogenated, the contents that are necessary with these products are very high, often from about 25% to 60% by weight of the unexpanded composition. In general, the incorporation of additives thus interferes with the foaming. In the case of crosslinked foams expanded without direct injection of gas into the extruder, a premix of polymers, fireproofing additives and the like, chemical expanders and crosslinking agents is made. This premix is extruded as a compact matrix, which then passes into an oven, bringing about the crosslinking and then the decomposition of the chemical agents as gases. It is known that the presence of a large amount of unmeltable additives makes the preparation of the mixture difficult, or even affects the homogeneity of the expansion in the oven due to a lack of homogeneity of the additives.

Each additive particle is a potential site for the growth of a gas bubble, and overabundant nucleation is often observed, which is harmful to the foam quality, especially for very-low-density foams (from 10 to 25 kg/m³). Furthermore, each particle mounted in the cell walls constitutes a potential structural defect that may be harmful to the integrity of the cell wall and thus a source of rupture, then causing opening of the cells, which reduces the insulating efficacy of the foam (transmission of water vapor and heat).

Finally, particles of very different nature, but of very small particle size, known as nanoparticles, have been known for 25 years. However, it is only in the last ten years that studies concerning the use of nanocomposites in flame retardant systems have undergone considerable growth. Nanocomposites generate particular interest for two essential reasons: firstly, they can generate specific effects (physical or chemical) not observed in the other classes of fireproofing systems and secondly they are effective at low levels of incorporation (typically less than 5% by mass).

Improving the heat stability of polymers by incorporating lamellar silicates was demonstrated in the 1960s on PMMA. Similar results were then observed on other polymers, such as polyimides or silicone elastomers. The degradation temperature of these polymers is increased by several tens of degrees in the presence of nanofillers.

Lamellar silicates also significantly modify the fire behavior of polymers. From the 1990s, the NIST (National Institute of Standards and Technology) conducted numerous tests on the use of montmorillonite and fluorhectorite in various polymers, such as PPgMA, PS, PA6, PA12 and epoxy resins. The contents used always remain below 10% by mass. These studies show that the presence of these phyllosilicates leads to a marked reduction in the peak value and in the average value of the heat release rate (HRR) during combustion, measured with a cone calorimeter.

It appears that the action of nanocomposites does not by itself ensure an efficient fire resistance liable especially to overcome the norm thresholds. Many recent studies are directed toward combining nanocomposites with other flame-retardant systems, such as phosphorus compounds, halogenated compounds, melamine derivatives and carbon nanotubes.

Carbon nanotubes have been used as flame-retardant systems in various polymers. In EVA, the results show that at relatively low levels of incorporation (3% and 5%), nanotubes lead to a reduction in the HRR peak for EVA measured with a cone calorimeter, by promoting carbonization of the polymer. The results are better than with modified clays. The combination of carbon nanotubes and modified clays leads to a synergistic effect that is thought to be the origin of the perfection of the surface of the formed residue.

The search for an alternative to halogenated products for improving the fire behavior of polymers used in insulating foams may lead to numerous solutions, the viability of which is also associated with cost or processability factors. The most advantageous performance qualities are obtained for multicomponent systems in which the complexity of the compositions is reflected by mechanisms of action that are also complex.

The use of hydrated minerals represents a drawback associated with the very high levels of incorporation usually used, and which is incompatible with the foaming of a thermoplastic and with a use in heat insulation.

Finally, the metering of these products, which is necessary for obtaining acceptable fire resistance, thus generally affects the mechanical properties of the finished product. In addition, in view of their high concentration, some of these flame-retardant additives run the risk of migrating to the surface of the product. Their uniform distribution within the product is thus no longer ensured.

### OBJECT OF THE INVENTION

One object of the present invention is to propose a polymeric foam that does not have the mentioned drawbacks, or has them to only a minor extent.

A subject of the invention is also a process for manufacturing flame-retardant foams and the use of the foams thus obtained.

In accordance with the invention, this objective is achieved by means of a foam based on a mixture comprising
a. a polymer composition comprising one or more homopolymers, statistical copolymers or block copolymers, which are thermoplastic and/or elastomeric, or mixtures thereof, optionally crosslinked,
b. from 0.05% to 10% by weight of the mixture of carbon nanotubes, and
c. from 0.05% to 15% by weight of the mixture of red phosphorus.

### GENERAL DESCRIPTION OF THE INVENTION

In order to solve the problem mentioned above, the present invention thus proposes, so as to improve the flameproof behavior of polymeric foams, to add to the thermoplastic and/or elastomeric polymer a relatively small amount of carbon nanotubes and of red phosphorus, as indicated in claim 1.

Specifically, one of the possibilities for obtaining a flame-retardant effect is to use products that are capable of forming a carbonized or vitrified insulating layer at the surface of the foam.

It has been found that the formation of such a layer can be facilitated by incorporating nanometric fillers, clays and/or carbon nanotubes, which are capable of limiting the transfers of polymer decomposition products at the first stages of decomposition and of inducing, via a catalytic effect, the formation of carbonization. It has also been observed that this effect may be advantageously combined with that of certain phosphorus additives.

Consequently, by virtue of the combination of flame retardants based on carbon nanotubes and red phosphorus, polymeric foams with improved fireproofing characteristics are obtained.

In the context of the present invention, the term “thermoplastic and/or elastomeric polymers” means any polymer that is suitable for preparing polymeric foams and which is either solely thermoplastic, or solely elastomeric, or both.

Specifically, besides purely thermoplastic polymers, i.e. polymers that have no elastomeric properties, on the one hand, and non-thermoplastic crosslinked elastomers with no thermoplastic properties, which are often generically grouped under the term “rubbers”, on the other hand, there are polymers that are both thermoplastic and elastomeric, namely polymers known as TPEs. The latter are generally divided into six commercially available generic classes: block styrene copolymers, polyolefin blends, elastomeric alloys, thermoplastic polyurethanes, thermoplastic copolyesters and thermoplastic polyamides.

Among the thermoplastic polymers, the ones that are particularly preferred are polyolefins, especially ethylene homopolymers, for example LLDPE, LDPE and HDPE; copolymers of the ethylene random, block, heterophase or branched type, for example EVA, EBA, EMA; homopolymers and copolymers of propylene random, block, heterophase or branched type, and similarly PE and PP of metallocene type. These polyolefins may either be used individually or as a mixture.

Among the elastomeric polymers, mention may be made of natural and synthetic rubber (polyisoprene), polybutadienes including copolymers with styrene, isobutene or isoprene, ethylene-propylene copolymers and certain linear long-chain polyurethanes or polysiloxanes (silicones).

Preferably, these elastomeric (co)polymers are chosen from acrylate-butadiene rubber (ABR), copolymers of ethyl or of other acrylates and a small amount of monomer facilitating vulcanization (ACM), terpolymers of allyl glycidyl ether, ethylene oxide and epichlorohydrin (AECO), copolymers of ethyl or other ethylene acrylates (AEM), terpolymers of tetrafluoroethylene, trifluoro-nitrosomethane and nitrosoperfluorobutyric (AFMU), copolymers of ethyl or other acrylates and acrylonitrile (ANM), polyester urethane (AU), bromo-isobutene-isoprene rubber (bromobutyl rubber) (BIIR), butadiene rubber (BR), polychlorotrifluoroethylene (CFM), chloro-isobutene-isoprene rubber (chloro rubber) (CIIR), chloro polyethylene (CM), epichlorohydrin rubber (CO), chloroprene rubber (CR), chlorosulfone polyethylene (CSM), copolymers of ethylene oxide and epichlorohydrin (ECO), copolymers of ethylene-vinyl acetate (EAM), terpolymers of ethylene, propylene and a diene with a residual unsaturated portion of the diene in the side chain (EPDM), ethylene-propylene copolymers (EPM), polyetherurethane (EU), perfluoro rubber of polymethylene type in which all the substituents on the polymer chain are fluoro, perfluoroalkyl or perfluoroalkoxy groups (FFKM), fluoro rubber of polymethylene type containing fluoro and perfluoroalkoxy substituents on the main chain (FKM), silicone rubbers containing fluoro, vinyl and methyl substituents on the polymer chain (FVMQ), polyoxypropylene rubber (GPO), isobutene-isoprene rubber (butyl rubber) (IIR), polyisobutene (IM), isoprene rubber (synthetic) (IR), silicone rubber exclusively containing methyl substituents on the polymer chain (MQ), nitrile-butadiene rubber (nitrile rubber) (NBR), nitrile-isoprene rubber (NIR), natural rubber (NR), pyridine-butadiene rubber (PBR), silicone rubber containing as many methyl groups as phenyl groups on the polymer chain (PMQ), pyridine-styrene-butadiene rubber (PSBR), silicone rubber containing methyl, phenyl and vinyl substituents on the polymer chain (PVMQ), rubber containing silicon in the polymer chain (Q), styrene-butadiene rubber (SBR), rubber containing sulfur in the polymer chain (except for CR-based copolymers) (T), silicone rubber containing as many methyl substituents as vinyl substituents in the polymer chain (VMQ), carboxylic-nitrile butadiene rubber (carboxynitrile rubber) (XNBR), carboxylic-styrene butadiene rubber (XSBR) and polyether-polyester block thermoplastic rubber (YBPO). Among these, acrylonitrile-butadiene rubber (NBR), ethylene-propylene-diene rubber (EPDM), styrene-butadiene rubber (SBR) or butyl rubber (IIR) is preferably used.

The above elastomeric polymers may be used alone or as mixtures with other elastomeric polymers and/or thermoplastic polymers, for example acrylonitrile-butadiene rubber (NBR) as a mixture with polyvinyl chloride (PVC).

Crosslinking makes it possible to improve the foams in many respects as regards their mechanical properties, for example so as to obtain finer cell structures. Generally obligatory for polymers of the “rubber” group, it may also advantageously be applied in the case of thermoplastic polymers. Even though, strictly speaking, the latter are then no longer thermoplastic, they will nevertheless be considered for the sake of simplicity as being thermoplastic polymers in the context of the present invention.

Consequently, the above polymers, in particular rubbers, preferably comprise a crosslinking system (vulcanization system) comprising one (or more) crosslinking agents taken from among all the crosslinking agents formed by sulfur, organic peroxides, metal oxides, resins and other vulcanizing products, and also, where appropriate, crosslinking coagents, especially vulcanization activators and accelerators. In practice, the mixture according to the invention may comprise between 0 and 10% by weight of the mixture, and preferably between 1% and 6% by weight, of vulcanizing agent and, where appropriate, between 0 and 5% by weight of vulcanization auxiliaries (coagents), for example vulcanization activators (e.g. zinc oxide), vulcanization accelerators (e.g. accelerators of mercapto, sulfenamide, thiuram, guanidine, dithiocarbamate or amine type), vulcanization retarders (e.g. based on phthalic anhydride, N-cyclohexylthiophthalimide), etc.

Carbon nanotubes (CNT) have a particular crystal structure, of closed or open hollow tubular form, composed of atoms regularly arranged in pentagons, hexagons and/or heptagons. In principle, any type of carbon nanotube is suitable for use in the context of the invention, especially monoleaflet carbon nanotubes and multileaflet carbon nanotubes, with a diameter of between 2 and 30 nm, a length of between a few hundred nm and several micrometers, the surface of which may or may not be covered with functional groups (alcohols, amines, carboxylic acids, etc.). Examples of CNTs that may be used are, for example, Nanocyl®-NC 7000 produced and supplied by the company Nanocyl, Belgium, or the Fibril® nanotubes from Hyperion, USA.

The amount of carbon nanotubes is generally in a range of between 0.05% and 10% by weight and preferably from 0.5% to 5% by weight of the mixture.

For the purposes of the present invention, “red phosphorus” denotes the various colored allotropic varieties of phosphorus (red, violet or black phosphorus) sold under the name red phosphorus.

The amount of red phosphorus in the mixture is generally between 0.05% and 15% by weight relative to the total weight of the mixture; preferably, this amount is between 0.5% and 10% by weight. In general, it is desirable to use the red phosphorus in finely divided form, for example in the form of particles with a mean diameter not exceeding 200 μm and preferably between 5 and 50 μm. Among the types of red phosphorus that may be used in the context of the present invention, mention may be made of Exolit RP 692 (Clariant), Masteret 15460 B₂XF or Masteret 10460 B₂XF from Italmatch.

In one advantageous form of the invention, said mixture may also contain up to 10% by weight of nanoclay(s), preferably from 0.1% to 6% by weight and in particular from 1°/0 to 5% by weight. It is also desirable to use the nanoclays in finely divided form, for example in the form of particles with a mean diameter not exceeding 30 μm and preferably between 0.1 and 10 μm. Examples of suitable nanoclays are Cloisite 20A (Southern Clay Products, USA), Bentone 2106 (Elementis Specialties, Scotland).

The choice of foaming agent is not critical. In principle, any foaming agent conventionally used for the foaming of thermoplastic or elastomeric polymers may also be used in the context of the present invention, such as chemical foaming agents, for instance azobisisobutyronitrile, azodicarbonamide, dinitrosopentamethylenetetramine, 4,4′-oxybis(benzenesulfonyl hydrazide), diphenylsulfone-3,3′-disulfohydrazide, benzene-1,3-disulfohydrazide, p-toluene-sulfonyl semicarbazide; or physical foaming agents, in particular foaming gases, such as isobutane, nitrogen or CO₂, where appropriate in supercritical form, according to any embodiment that is well known in the prior art comprising, depending on the case, extrusion operations and/or maintenance under pressure followed by depressurization and/or heating, etc. Advantageously, isobutane is used alone or as a mixture with another foaming agent, for example for foaming polyolefins.

In the preparation of a crosslinked polymeric foam, the start of foaming may take place in an already partially crosslinked state of the polymer(s). This measure makes it possible, for example, to increase the viscosity of the composition or even to condition the regularity and fineness of the cell structure finally obtained. In this case, the crosslinking continues during foaming and, optionally, afterwards.

However, the crosslinking may also be started during or even after foaming (especially in the combination of a physical expander, i.e. an agent that is active under the effect of depressurization, such as isobutane, and of a silane crosslinking agent).

The foams expanded by direct injection on extrusion of gases other than air or nitrogen may advantageously contain volume stabilizers or stabilizing agents (also known as permeation modifiers), for example from 0 to 10% by weight of one or more volume stabilizers, for instance saturated-chain fatty acid amides, especially stearamide, palmitamide, etc.; saturated-chain fatty acid partial esters of polyols, especially glyceryl alpha-monostearate, etc.

The foams obtained preferably essentially comprise closed cells and generally have a density of less than 500 kg/m³, preferably less than 250 kg/m³ and in particular from 10 to 100 kg/m³.

Other additives that may commonly be used are especially antistatic additives, UV stabilizers, antioxidants, pigments, agents for controlling and/or regularizing the cell structure to improve the foam quality: nucleating agents to make the cells finer (for example talc, calcium carbonate, finely precipitated silica, etc.) or denucleating agents to increase the size of the cells (polyethylene oxide waxes, candelilla waxes, etc.) and/or agents that absorb, reflect or diffract infrared rays for improvement of the heat insulation (for example particles of metals or metal oxides, mica, titanium dioxide, graphite, carbon black, kaolin, etc.). More specifically for the crosslinked elastomeric foams (vulcanization), the additives usually used have, inter alia, the following functions: anti-ozone agents, fireproofing agents, pigments, antioxidants, UV stabilizers, lubricants, plasticizers, fillers, matting agents, antistatic agents, heat stabilizers, release agents, vulcanizing agents, vulcanization retardants, vulcanization accelerators, expanders, expansion activators, etc.

One particularly advantageous use of these flame-retardant polymeric foams is their use as insulating, protective, shock-absorbing and/or decorative material, in the form of panels or plates, tubes or cladding, profiles, etc., alone or as part of a composite material.

The invention also relates to a process for manufacturing a flame-retardant polymeric foam comprising one or more homopolymers, statistical copolymers and/or block copolymers, which are thermoplastic and/or elastomeric, or mixtures thereof, 0.05% to 10% and preferably from 0.5% to 5% by weight of carbon nanotubes and 0.05% to 15% and preferably from 0.5% to 10% by weight of red phosphorus, and optionally up to 10% by weight of nanoclay, relative to the total weight of the mixture, partially premixed or individually metered out, are mixed together and the mixture thus obtained is expanded in the presence of a foaming agent, so as to obtain a foam.

In particular, the invention relates to a process for manufacturing a foam, comprising the following steps:
a. metering out and mixing of one or more homopolymers, block or random copolymers, which are thermoplastic and/or elastomeric, or mixtures thereof, carbon nanotubes and red phosphorus and optionally other additives, premixed or individually metered out;
b. plasticization of the resulting mixture by heating to high temperature and mixing to entirely melt the mass and homogenize it;
c. extrusion through a temperature-controlled die;
d. initiation of foaming, which leads to the formation of gas bubbles, causing formation of the foam;
e. where appropriate, cooling, drawing and guiding of the foam.

In this process, the initiation of foaming may take place, on the one hand, immediately on exiting the extrusion die by means of a substantial drop in pressure, which takes place on passing into open air in the case of a foaming gas injected in step b. and/or c. or in the case of a chemical foaming agent introduced in step a., b. and/or c. that is already decomposed on exiting the die. On the other hand, this initiation may also take place by subsequent activation of the chemical foaming agent (e.g. after a period of storage of the unexpanded mixture) by heating, for example in an oven at a temperature above the decomposition temperature of the chemical foaming agent or by irradiation (microwaves, UV, etc.) or via any other suitable means as a function of the nature of the chemical foaming agent in the case of a chemical foaming agent introduced in step a., b. and/or c., but which is not yet decomposed on exiting the die.

In point of fact, when a chemical foaming agent is already activated before exiting the extrusion die, it decomposes so as to produce a gas that remains in solution at the pressure prevailing in the extruder and thus behaves in the same manner as a physical foaming agent (foaming gas), which dilates once the pressure falls below a certain value on exiting the die (the extrusion generally being performed in open air).

In particular, in a first variant, the invention relates to a process for manufacturing a foam by extrusion with direct injection of foaming gas. Such a process comprises the following steps:
a.1. metering out of one or more homopolymers, block or random copolymers, which are thermoplastic and/or elastomeric, or mixtures thereof, carbon nanotubes and red phosphorus and optionally other additives, premixed or individually metered out, fed into an extruder, for example a single-screw, twin-screw, co-rotating or counter-rotating extruder;
b.1.1. plasticization of the mixture of polymers and additives by heating to high temperature of the cylinder and mixing with the screw to fully melt the mass and homogenize it;
b.1.2. injection of a foaming gas into the extruder, preferably at the place where the viscosity of the mixture of polymers and additives is most appropriate;
b.1.3. homogenization of the resulting mass of polymers, additives and foaming gas;
b.1.4. preferably, cooling of the mass in the final cooler regions of the cylinder, static cooling section, homogenization;
c.1. extrusion through a temperature-controlled die, having a cross section of predefined shape according to the final application of the foam,
d.1. expansion of the foaming gas in the mass undergoing a substantial drop in pressure on exiting the die, which brings about the formation of gas bubbles, causing the formation of foam in open air;
e.1. where appropriate, cooling, drawing and guiding of the foam.

In a second variant, the step of injection of the physical foaming agent (foaming gas) may be replaced by the introduction of a chemical foaming agent during step a., b. and/or even c. Consequently, the invention also relates to a process for manufacturing a foam using a chemical foaming agent, comprising the following steps:
a.2. metering out of one or more homopolymers, block or random copolymers, which are thermoplastic and/or elastomeric, or mixtures thereof, carbon nanotubes and red phosphorus and optionally other additives, premixed or individually metered out, fed into a mixer;
b.2. plasticization of the resulting mixture by heating to high temperature of the cylinder and mixing to fully melt the mass and homogenize it;
   introduction of at least one chemical foaming agent into step a.2., b.2. and/or even during c.2.;
c.2. extrusion through a temperature-controlled die, optionally cooling and storage of the nonexpanded mixture,
d.2. initiation of foaming by heating the mixture to a temperature above the decomposition temperature of the chemical foaming agent or by irradiation, which leads to the formation of gas bubbles, causing the formation of the foam;
e.2. where appropriate, cooling, drawing and guiding of the foam.

In another variant of the foam manufacturing process above, it comprises the introduction into one or more of the steps a.-c. of a crosslinking system comprising at least one crosslinking agent and optionally one or more crosslinking coagents, such as those described above.

Preferably, the carbon nanotubes and optionally the red phosphorus, where appropriate also the nanoclays, may be premixed, individually or together, with some of the polymer before step a. above in order to improve or accelerate their mixing in step a. Such a premix (also known as a masterbatch) may also concern some or all of the other additives envisioned.

The temperatures to be used in the process obviously depend on several factors, including the nature of the ingredients used, the type of apparatus and the operating mode chosen, etc. A person skilled in the art in this field, by virtue of his experience, will have no problem in selecting the appropriate temperature ranges as a function of the given operating conditions.

For purely illustrative purposes in a process by direct injection of a foaming gas (first variant), for example in the case of an LDPE, the temperature of the cylinder in step b. is preferably chosen such that the bulk temperature is between 130 and 180° C.; the temperature in step b.1.4. will then be, for example, from 100 to 140° C., as a function of the temperature chosen in step b.1.1. The extrusion temperature in step c.1. is important for the formation and stability of the foam produced and, in such a case, will be controlled so as to have a lower temperature, for example from 90 to 120° C., again as a function of the temperature in step b.1.4. The extruded foam may be guided, by an auger virtually without tension, in a cooling section (air or water or both) to set the desired structure.

In particular, in one preferred embodiment of the second variant of the process, the invention also relates to a process for manufacturing foam by extrusion of an unexpanded matrix (steps a.2.-c.2.), and then passage of this matrix through a subsequent heat treatment section (step d.2.), in continuous or batch mode, bringing about the crosslinking and expansion.

Such a process preferably comprises the following standard steps (the step of preparing a masterbatch of starting materials described herein more particularly in relation with the second variant also applying to the first variant of the process):

Preparation of a Masterbatch of Starting Materials

This step of the process may be performed in various ways:
either in batch mode, defined batches of material are processed;
or in continuous mode.

The starting materials may be in various forms: solid (granules, beads, powders, etc.) or liquid;

The types and functions of the materials are varied, and mention may be made, inter alia, of the following categories:
elastomeric resin(s)
mineral fillers
plasticizers
lubricants
flame retardants
colorants
antioxidants
anti-ozone agents
chemical foaming agents
vulcanizing agents
vulcanization accelerators/retardants
processing additives
etc.

In the case of batch manufacture of a masterbatch of materials, the process is performed, for example, according to the following sequence:

a defined batch of some or all of the starting materials is conveyed to a blender (“internal mixer”) responsible for dispersing and aggregating the various components into a paste;

the paste aggregates leaving the blender are poured into a mixer, for example of the counter-rotating roll type. This machine must perform the homogenization of the materials, by controlling the temperature, the spin speed and the mixing time. The spin speed may be adapted according to the order and nature of the components during the successive additions. After the mixing cycle, strips of homogenized material are obtained.

If only some of the starting materials were added, the strips obtained from step b) are then passed back into the blender, adding thereto the additional components, this being done in several sub-sequences if necessary. Intermediate monitoring of the viscosity as a function of the temperature may be performed on the partial strips of mixture, these strips being optionally stored between two mixing sub-sequences.

In any case, the parameters must be adapted so as not to start the vulcanization or to activate the decomposition of the foaming agent during the addition of these compounds.

When all the materials have been added, the masterbatch is extracted from the mixer rolls, in the form of strips of material.

After evaluation and validation of the masterbatch load (laboratory monitoring of the variation in viscosity during vulcanization, caused by an increase in temperature), the strips of masterbatch are stored—for a limited time in view of the presence of the temperature-sensitive reagents—for the extrusion step.

The masterbatch may also be manufactured in continuous mode, by feeding an extruder with all the materials, at one or more points of entry—for solid and/or liquids—distributed along the cylinder. The masterbatch may be obtained, for example, in the practical form of granules, which will be stored for the extrusion step.

Extrusion of the Masterbatch

The strips or granules of masterbatch from the preceding step 1 feed an extruder, for example a single-screw or twin-screw extruder (co-rotating or counter-rotating), whose role is to mix in the molten state all the components and to form them through a die.

Depending on the die used, a plate or a hollow tube of compact material may be obtained, inter alia.

Causing vulcanization of the extruded mixture and/or thermal decomposition of the chemical foaming agent at this stage should also be avoided, by means of controlling the bulk extrusion temperature.

Crosslinking—Expansion by Heat Treatment The mold or the compact profile exiting the extruder is then treated with a raise in temperature. This step may be performed:

continuously:
the compact mold or the compact profile enters an oven;
the first part of the oven serves to start the vulcanization (=crosslinking) of the chains of the elastomeric resin;
the second part of the oven causes decomposition of the chemical foaming agent, which releases gases. These gases expand the material as bubbles, the size of which is regulated by the degree of crosslinking of the walls of surrounding material and the presence of cell-forming additives;
the formed foam leaves the oven.

in batch mode:
the compact mold or the compact profile are chopped into lengths;
the lengths are placed in an oven of given volume;
a temperature program allows crosslinking of the elastomeric chains, and then decomposition of the chemical agent leading to expansion of the mold or profile;
the resulting foam at the end of the program is removed from the oven.

Subsequent Operations
cooling (water jets);
drying (air blown onto the foam);
chopping;
packaging;
storage.

As another embodiment of the second variant of the process (extrusion of an unexpanded mold (steps a.2.-c.2.), followed by passage of this mold through a subsequent heat-treatment section (step d.2.), in continuous or batch mode, causing crosslinking and expansion), mention may be made of the manufacture of polyolefin foams crosslinked with agents of peroxide type, crosslinking coagents, and expanded by the use of chemical expanders.

Such a process preferably comprises the following standard steps:
1. metering out of the components of the formulation (polymers and additives, crosslinking agents and coagents, expanders) in a single-screw or twin-screw extruder (co-rotating or counter-rotating), so as to plasticize and homogenize the composition, the parameters being chosen so as not to prejudicially cause either crosslinking or decomposition of the chemical expanders;
2. extrusion of the mixture through a die, in the form of an unexpanded compact mold, in the form of a plate or a tube or in any other form;
3. optional calendering of the compact mold, for example if it is in the form of a plate;
4. drawing of the mold continuously in an oven, the first part of which serves to bring about partial crosslinking of the mixture, the second part serving both for the decomposition of the chemical expander(s), under the effect of the temperature, and the completion of the crosslinking, these two processes at a concomitant moment bringing about foaming of the matrix;
5. drawing of the expanded sheet on rolls, cooling, chopping of the edges, other finishing operations on the finished foam.

Step 1 may be preceded by manufacture of a number of masterbatches combining some of the components, for example the polymer(s) with certain additives, in a manner equivalent to that described above.

The equipment used for the manufacture of ordinary polymeric foams may be used in the manufacture of flame-retardant polymeric foams according to the invention.

### EXAMPLES

### 1. Compact Plates and Foams Obtained by Extrusion with Direct Injection of Gas

The tables below summarize the epiradiator fire tests (AFNOR NF P92-505) performed on compact plates and on foams. The results show the time required for ignition of a 3×7×7 cm³ plate (TTI), and the number of times that the sample extinguished over the 5 minutes of the test (N). The TTI and the N should be large for good fire behavior.

### Products and Reagents:

The following products and reagents were used for the tests:

APP: ammonium polyphosphate from Clariant: Exolit AP 422
Red P: red phosphorus from Clariant: masterbatch Exolit RP 692 concentrate containing 50% red phosphorus in low-density polyethylene
OP 1230: phosphinate from Clariant: Exolit OP 1230
CNT: carbon nanotubes from Nanocyl-NC 7000
Cloisite 20A: organomodified nanoclay from Southern Clay Products
OSV 90=90% concentrate of fatty acid amides Amid HT (Akzo Nobel) in 10% of EVA
LDPE: low-density polyethylene from Sabic: 1922T (density 919 kg/m³, MFI=22)

### Example 1.1

### Compact Plates

The comparative tests and tests according to the invention given below were performed on compact LDPE plates containing the indicated flame retardants in the amounts given in Table 1 below.

TABLE 1

| | | TTI (s) | N |
|---|---|---|---|
| 1 (Comp.) | LDPE | 67 | 1 |
| 2 (Comp.) | Plate made from an LDPE foam + halogenated | 89.5 | 8 |
| | flame retardant (brominated + Sb₂O₃) | | |
| 3 (Comp.) | 10% APP | 48 | 2.5 |
| 4 (Comp.) | 20% APP | 47 | 4 |
| 5(Comp.) | 10% CNT | 61.5 | 5 |
| 6 (Comp.) | 3% CNT | 105 | 1 |
| 7 (Comp.) | 10% Red P | 102 | 13.5 |
| 8 (Comp.) | 10% Cloisite 20A | 52 | 1 |
| 9 (Comp.) | 3% Cloisite 20A | 72 | 1 |
| 10 (Comp.) | 10% OP 1230 | 63 | 14 |
| 11 (Comp.) | 20% OP 1230 | 101 | 2 |
| 12 (Comp.) | 7% APP + 3% CNT | 44.5 | 2.5 |
| 13 (Comp.) | 7% APP + 3% Cloisite 20A | 44.5 | 2 |
| 14 | 7% OP 1230 + 3% CNT | 56 | 13.5 |
| 15 (Comp.) | 7% OP 1230 + 3% Cloisite 20A | 54.5 | 1 |
| 16 | 7% Red P + 3% CNT | 58 | 21 |
| 17 (Comp.) | 7% Red P + 3% Cloisite 20A | 60.5 | 1 |

### Example 1.2

### Flame-Retardant Foams

The following foams were extruded according to the process of foaming by direct injection of gas described previously; they comprise a foam stabilizer (fatty acid amides: stearamide+palmitamide) necessary to avoid collapse, when the foams are swollen with isobutane.

TABLE 2
Foam compositions

| | Composition n° | | | | | |
|---|---|---|---|---|---|---|
| | M72 (comp.) | | M73 | | M74 | |
| Products | parts | % by wt. | parts | % by wt. | parts | % by wt. |
| LDPE 2102TX00 (SABIC, | 85 | 81.7% | 71 | 68.9% | | 0.0% |
| LDPE density 921 kg/m³ − | | | | | | |
| MFI(190° C./2.16 kg)) = 2 | | | | | | |
| PLASTICYL (Masterbatch | 15 | 14.4% | 15 | 14.6% | 15 | 14.6% |
| 80% LDPE + 20% nanotubes) | | | | | | |
| Masterbatch 85.5/11.6/2.9% | | 0.0% | | 0.0% | 71 | 68.9% |
| LDPE/EVA/Cloisite 20A | | | | | | |
| Exolit RP 692 (MB 50% LDPE + | | 0.0% | 14 | 13.6% | 14 | 13.6% |
| 50% red P) | | | | | | |
| MB Talc (50% LDPE + 50% | 1 | 1.0% | | 0.0% | | 0.0% |
| talc) | | | | | | |
| OSV 90 | 3 | 2.9% | 3 | 2.9% | 3 | 2.9% |
| | 104 | 100.0% | 103 | 100.0% | 103 | 100.0% |

| | % conc. of | % of the | % of the | % of the |
|---|---|---|---|---|
| Masterbatch (MB) | the MB | composition | composition | composition |
| % CNT | 20% | 2.9% | 2.9% | 2.9% |
| % Cloisite 20A | 3% | 0.0% | 0.0% | 2.0% |
| % Red P | 50% | 0.0% | 6.8% | 6.8% |

TABLE 3
Results of the epiradiator combustion tests:

| | TTI (s) | N |
|---|---|---|
| Halogenated reference foam 25 kg/m³ | 22 | 3.5 |
| M72 (PEBD/CNT ) (comp.) | 5.5 | 1 |
| M73 (PEBD/CNT/Red P) | 10 | 5.5 |
| M74 (PEBD/CNT/Red P/Cloisite) | 10 | 6 |

The last two compositions indicate progress relative to the reference foam. An improvement in their cell structure and a reduction in the foam density may be obtained while taking care to ensure a sufficient dispersion of the nanotubes CNT, preferably by metering them out via a masterbatch (MB), for example in the chosen polyolefin and while avoiding an excessive concentration of CNT in the MB, which causes an excessive increase in viscosity thereof.

Specifically, when the masterbatch (MB) of CNT is re-extruded a first time as a compound, and then by making the foam from this compound (i.e. two extrusions in total), a few holes are still present, but they are markedly smaller, there are no detectable solid grains and the foam density reaches 27 kg/m³.

Consequently, by combining the carbon nanotubes and red phosphorus, and optionally even nanoclays, as flame retardants, very good results are obtained, especially as regards the self-extinguishing nature of foams according to the invention.

The following fire test (mass loss calorimeter, ASTM E2102-04a), performed on these foams, measures the total amount of heat released (THRR) during combustion and the maximum heat release (HRR):

TABLE 4
Results of the combustion tests with a cone calorimeter

| | HRR max | THRR | Mass | HRR max/g | THRR/g |
|---|---|---|---|---|---|
| Foam category/version | (kW/m²) | (MJ/m²) | (g) | (kW/g · m²) | (MJ/g · m²) |
| LDPE foam without | 199 | 10.94 | 3.6 | 3 | 55.27 |
| fireproofing agent | | | | | |
| Ref. halogenated | 189 | 15.16 | 3.11 | 4.87 | 60.77 |
| LDPE foam (see Table | | | | | |
| 1 ex. 2 (comp.)) | | | | | |
| CNT (M72) | 301 | 24.94 | 6.02 | 4.14 | 50 |
| CNT - Red P (M73) | 288 | 21.6 | 6.75 | 3 | 42 |
| CNT - Red P - Cloisite | 247 | 18.6 | 6.39 | 2.9 | 38.65 |
| (M74) | | | | | |

Relative to the weight of foam, the compositions M72, but especially M73 and M74 are better than the halogenated reference foam.

### 2. Vulcanized Elastomeric Foam Plates or Tubes Obtained by Extrusion and then Expansion after Heat Treatment

The following compositions were prepared according to the process described previously, of mixing the polymers and additives followed by extrusion of an unexpanded mold, and passage of this mold through a subsequent heat-treatment section, in continuous or batch mode, causing crosslinking and expansion.

### Example 2.1 (Reference, not Representative of the Invention)

### Foam Plate

TABLE 5
Foam composition

| | | % by |
|---|---|---|
| CHEMICAL NATURE | ROLE | weight |
| Butadiene-nitrile rubber | Elastomeric resin | 11.55 |
| Vinyl chloride-vinyl acetate | Resin, improvement of oil | 7.5 |
| copolymer | and ozone resistance, | |
| | fireproofing agent | |
| Polyvinyl chloride | Resin, improvement of oil | 7.5 |
| | and ozone resistance, | |
| | fireproofing agent | |
| Chlorosulfone polyethylene | Ozone, oxygen, heat resistance, | 3.4 |
| | resistance to chemical products, | |
| | mechanical strength; | |
| | processing aid | |
| Aluminum trihydroxide | Fireproofing agent | 24.1 |
| Microcrystalline paraffin wax | Anti-ozone agent | 1.7 |
| C₁₄₋₁₇ chlorinated paraffin | Fireproofing agent | 12.2 |
| Carbon black | Pigment | 2.3 |
| Zinc salt of 4- and 5-methyl- | Anti-degradant (O2, O3, etc.) | 0.1 |
| 2-mercaptobenzimidazole | | |
| Hexabromocyclododecane | Fireproofing agent | 3.4 |
| Antimony trioxide | Fireproofing synergist | 1.7 |
| Talc | Filler | 7.4 |
| Calcium stearate | Lubricant | 0.1 |
| Polyethylene glycol | Matting agent, antistatic agent, | 0.6 |
| | lubricant | |
| Epoxidized soybean oil | Acid stabilizer | 0.6 |
| Octyl diphenyl phosphate | Fire co-retardant, lubricant | 2.3 |
| Zinc oxide | Vulcanization accelerator, acid | 0.4 |
| | neutralizer | |
| Phenylenediamine compound | Antioxidant | 0.3 |
| (6PPD) | | |
| Magnesium stearate | Release agent | 0.1 |
| Zinc N-dibutyldithiocarbamate | Vulcanization accelerator | 0.3 |
| Azodicarbonamide | Chemical expander | 8.7 |
| Organic zinc salt | Expansion activator | 0.65 |
| Dispersion of sulfur in | Vulcanizing agent | 0.4 |
| elastomer | | |
| Benzenesulfonamide | Vulcanization retardant | 0.2 |
| compound | | |
| Zinc dimethyldithiocarbamate | Vulcanization accelerator | 1.8 |
| Zinc salt of 2-mercapto- | Vulcanization accelerator | 0.1 |
| benzothiazole | | |
| Dipentamethylene thiuram | Vulcanization accelerator | 0.6 |
| tetrasulfide | | |
| TOTAL | | 100.00 |

There are 43.7% by weight of flameproofing additives, of which nearly 26% are in solid form.

### Example 2.2 (representative of the invention)

### Foam Plate

TABLE 6
Foam composition

| | | % by |
|---|---|---|
| CHEMICAL NATURE | ROLE | weight |
| Butadiene-nitrile rubber | Elastomeric resin | 16.92 |
| Vinyl chloride-vinyl acetate | Resin, improvement of oil | 10.98 |
| copolymer | and ozone resistance, | |
| | fireproofing agent | |
| Polyvinyl chloride | Resin, improvement of oil | 10.98 |
| | and ozone resistance, | |
| | fireproofing agent | |
| Chlorosulfone polyethylene | Ozone, oxygen, heat resistance, | 4.97 |
| | resistance to chemical products, | |
| | mechanical strength; | |
| | processing aid | |
| Microcrystalline paraffin wax | Anti-ozone agent | 2.49 |
| Carbon black | Pigment | 3.37 |
| Zinc salt of 4- and 5-methyl-2- | Anti-degradant (O2, O3, etc.) | 0.15 |
| mercaptobenzimidazole | | |
| Antimony trioxide | Fireproofing synergist | 2.49 |
| Talc | Filler | 10.85 |
| Calcium stearate | Lubricant | 0.15 |
| Polyethylene glycol | Matting agent, antistatic agent, | 0.88 |
| | lubricant | |
| Epoxidized soybean oil | Acid stabilizer | 0.88 |
| Octyl diphenyl phosphate | Fire co-retardant, lubricant | 3.37 |
| Zinc oxide | Vulcanization accelerator, acid | 0.59 |
| | neutralizer | |
| Phenylenediamine compound | Antioxidant | 0.44 |
| (6PPD) | | |
| Magnesium stearate | Release agent | 0.15 |
| Zinc N-dibutyldithiocarbamate | Vulcanization accelerator | 0.44 |
| Azodicarbonamide | Chemical expander | 12.74 |
| Organic zinc salt | Expansion activator | 0.95 |
| Dispersion of sulfur in elastomer | Vulcanizing agent | 0.59 |
| Benzenesulfonamide compound | Vulcanization retardant | 0.29 |
| Zinc dimethyldithiocarbamate | Vulcanization accelerator | 2.64 |
| Zinc salt of 2-mercapto- | Vulcanization accelerator | 0.15 |
| benzothiazole | | |
| Dipentamethylene thiuram | Vulcanization accelerator | 0.88 |
| tetrasulfide | | |
| Carbon nanotubes | Fireproofing agent | 2.88 |
| Nanoclays | Fireproofing agent | 2.03 |
| Red phosphorus | Fireproofing agent | 6.77 |
| TOTAL | | 100.00 |

17.53% by weight of fireproofing additives are present.

### 3. Crosslinked Polyolefin Foam Plates or Tubes Obtained by Extrusion and then Expansion by Heat Treatment

The following compositions were prepared according to the process, described previously, of mixing of the polymers and additives followed by extrusion of an unexpanded mold in plate form, and passage of this mold through a subsequent heat-treatment section—in this case in continuous mode—causing its crosslinking and expansion.

TABLE 7
Foam composition

| | | Reference | |
|---|---|---|---|
| | | (not repre- | Composition |
| | | sentative | represen- |
| | | of the | tative of |
| | | invention) | the invention |
| CHEMICAL NATURE | ROLE | % by weight | % by weight |
| Low density | Polyolefin resin | 59.99% | 66.07% |
| polyethylene (LDPE) | | | |
| Azodicarbonamide | Chemical expander | 15.42% | 16.99% |
| Masterbatch containing | Crosslinking agent | 1.52% | 1.67% |
| 40% by weight of | | | |
| dicumyl peroxide | | | |
| Carbon black | Pigment | 0.47% | 0.52% |
| Masterbatch containing | Halogenated | 19.93% | 0.00% |
| 80% by weight of | fireproofing | | |
| brominated fireproofing | agent + synergist | | |
| agent + antimony | | | |
| trioxide 2/1 | | | |
| Masterbatch containing | Infrared-reflecting | 2.66% | 2.93% |
| 40% by weight of | pigment | | |
| aluminum platelets | | | |
| Carbon nanotubes | Fireproofing agent | 0.00% | 2.97% |
| Red phosphorus | Fireproofing agent | 0.00% | 6.61% |
| Nanoclays | Fireproofing agent | 0.00% | 2.25% |
| TOTAL | | 100% | 100% |

1. A flame-retardant polymeric foam based on a mixture comprising:
a. a polymer composition comprising one or more homopolymers, random copolymers or block copolymers, which are thermoplastic and/or elastomeric, or mixtures thereof, optionally crosslinked,
b. from 0.05% to 10%, preferably from 0.5% to 5%, by weight of carbon nanotubes, and
c. from 0.05% to 15%, preferably from 0.5% to 10%, by weight of red phosphorus, relative to the total weight of the mixture.

2. The foam as claimed in claim 1, also comprising up to 10% by weight of nanoclay(s), preferably from 0.1% to 6% by weight and in particular from 1% to 5% by weight.

3. The foam as claimed in claim 1, with a density of less than 500 kg/m3, preferably less than 250 kg/m3 and in particular from 10 to 100 kg/m3.

4. The foam as claimed in claim 1, characterized in that it also comprises from 0 to 10% by weight of one or more volume stabilizers.

5. The foam as claimed in claim 1, characterized in that it also comprises antistatic additives, UV stabilizers, antioxidants, pigments and/or nucleating agents.

6. The foam as claimed in claim 1, characterized in that it essentially comprises closed cells.

7. The use of the foam as claimed in claim 1 as an insulating, protective, shock-absorbing and/or decorative material for the manufacture of panels, tubes, profiles, etc.

8. A process for manufacturing a flame-retardant polymeric foam, characterized in that one or more homopolymers, block or random copolymers, which are thermoplastic and/or elastomeric, or mixtures thereof, premixed or individually metered out, is (are) mixed with 0.05% to 10% and preferably from 0.5% to 5% by weight of carbon nanotubes and from 0.05% to 15% and preferably from 0.5% to 10% by weight of red phosphorus, and optionally up to 10% by weight of nanoclay(s), relative to the total weight of the mixture, and in that the mixture thus obtained is expanded in the presence of a foaming agent so as to obtain a foam.

9. The foam manufacturing process as claimed in claim 8, comprising the following steps:
a. metering out and mixing of one or more homopolymers, block or random copolymers, which are thermoplastic and/or elastomeric, or mixtures thereof, carbon nanotubes and red phosphorus and optionally other additives, premixed or individually meteed out;
b. plasticization of the resulting mixture by heating to high temperature and mixing to entirely melt the mass and homogenize it;
c. extrusion through a temperature-controlled die,
d. initiation of foaming, which leads to the formation of gas bubbles, causing formation of the foam,
e. where appropriate, cooling, drawing and guiding of the foam, in which the initiation of foaming takes place either on exiting the die by means of a large drop in pressure in the case of a foaming gas injected in step b. and/or c. or in the case of a chemical foaming agent introduced in step a., b. and/or c. that is already decomposed on exiting the die, or by means of activation of the chemical foaming agent by heating to a temperature above the decomposition temperature of the chemical foaming agent or by irradiation in the case of a chemical foaming agent introduced in step a., b. and/or c. which is not yet decomposed on exiting the die.

10. The foam manufacturing process as claimed in claim 9, comprising the following steps:
a.1. metering out of one or more homopolymers, block or random copolymers, which are thermoplastic and/or elastomeric, or mixtures thereof, carbon nanotubes and red phosphorus and optionally other additives, premixed or individually metered out, fed into an extruder;
b.1.1. plasticization of the resulting mixture by heating to high temperature of the cylinder and mixing to fully melt the mass and homogenize it;
b.1.2. injection of a foaming gas into the extruder;
b.1.3. homogenization of the resulting mixture;
b.1.4. partial cooling of the mixture and homogenization;
c. 1. extrusion through a temperature-controlled die,
d. 1. expansion of the foaming gas in the mass undergoing a substantial drop in pressure on exiting the die, which brings about the formation of gas bubbles, causing the formation of foam in open air;
e. 1. where appropriate, cooling, drawing and guiding of the foam.

11. The foam manufacturing process as claimed in claim 9, comprising the following steps:
a.2. metering out of one or more homopolymers, block or random copolymers, which are thermoplastic and/or elastomeric, or mixtures thereof, carbon nanotubes and red phosphorus and optionally other additives, premixed or individually metered out, fed into a mixer;
b.2. plasticization of the resulting mixture by heating to high temperature of the cylinder and mixing to fully melt the mass and homogenize it; introduction of at least one chemical foaming agent into step a.2. and/or b.2;
c.2. extrusion through a temperature-controlled die, optionally cooling and storage of the nonexpanded mixture,
d.2. initiation of foaming by heating the mixture to a temperature above the decomposition temperature of the chemical foaming agent or by irradiation, which leads to the formation of gas bubbles, causing the formation of the foam;
e.2. where appropriate, cooling, drawing and guiding of the foam.

12. The foam manufacturing process as claimed in claim 11, comprising the introduction into one or more of the steps a., b. and/or c. of a crosslinking system comprising at least one crosslinking agent, and optionally one or more crosslinking coagents.

13. The foam as claimed in claim 2, with a density of less than 500 kg/m3, preferably less than 250 kg/m3 and in particular from 10 to 100 kg/m3.

14. The use of the foam as claimed in claim 2 as an insulating, protective, shock-absorbing and/or decorative material for the manufacture of panels, tubes, profiles, etc.

15. The use of the foam as claimed in claim 4 as an insulating, protective, shock-absorbing and/or decorative material for the manufacture of panels, tubes, profiles, etc.

16. The use of the foam as claimed in claim 5 as an insulating, protective, shock-absorbing and/or decorative material for the manufacture of panels, tubes, profiles, etc.

17. The use of the foam as claimed in claim 6 as an insulating, protective, shock-absorbing and/or decorative material for the manufacture of panels, tubes, profiles, etc.

18. The foam manufacturing process as claimed in claim 8, comprising the following steps:
a.1. metering out of one or more homopolymers, block or random copolymers, which are thermoplastic and/or elastomeric, or mixtures thereof, carbon nanotubes and red phosphorus and optionally other additives, premixed or individually metered out, fed into an extruder;
b.1.1. plasticization of the resulting mixture by heating to high temperature of the cylinder and mixing to fully melt the mass and homogenize it;
b.1.2. injection of a foaming gas into the extruder
b.1.3. homogenization of the resulting mixture;
b.1.4. partial cooling of the mixture and homogenization;
c.1. extrusion through a temperature-controlled die,
d. 1. expansion of the foaming gas in the mass undergoing a substantial drop in pressure on exiting the die, which brings about the formation of gas bubbles, causing the formation of foam in open air;
e.1. where appropriate, cooling, drawing and guiding of the foam.

19. The foam manufacturing process as claimed in claim 8, comprising the following steps:
a.2. metering out of one or more homopolymers, block or random copolymers, which are thermoplastic and/or elastomeric, or mixtures thereof, carbon nanotubes and red phosphorus and optionally other additives, premixed or individually metered out, fed into a mixer;
b.2. plasticization of the resulting mixture by heating to high temperature of the cylinder and mixing to fully melt the mass and homogenize it; introduction of at least one chemical foaming agent into step a.2. and/or b.2;
c.2. extrusion through a temperature-controlled die, optionally cooling and storage of the nonexpanded mixture,
d.2. initiation of foaming by heating the mixture to a temperature above the decomposition temperature of the chemical foaming agent or by irradiation, which leads to the formation of gas bubbles, causing the formation of the foam;
e.2. where appropriate, cooling, drawing and guiding of the foam.

20. The foam manufacturing process as claimed in claim 8, comprising the introduction into one or more of the steps a., b. and/or c. of a crosslinking system comprising at least one crosslinking agent, and optionally one or more crosslinking coagents.
